(19) United States
(12) Patent Application Publication
(10) Pub. No.: US 2007/0247447 A1
(43) Pub. Date: Oct. 25, 2007

(54) Mobile display

(76) Inventors: Kevin James Mack, Berkeley, CA (US); Narayan Dhruvaraj Melgiri, San Francisco, CA (US); Matthew John Wise, Berkeley, CA (US)

Correspondence Address: KEVIN J. MACK, 242 CURTNER AVE SUITE N, PALO ALTO, CA, 94306, US

(21) Appl. No.: 11/409,319

(22) Filed: Apr. 24, 2006

(51) Int. Cl. G09G 5/00

(52) U.S. Cl. 345/204

(57) ABSTRACT

A method and system for displaying visual content is disclosed. In some embodiments the system comprises a processor configured to process visual content that is to be displayed on the mobile display, a storage device coupled to the mobile display and adapted to store the visual content, and an interface configured to facilitate the transfer of the visual content from an external source to the storage device.

### FIELD OF THE INVENTION

The invention relates generally to a method and system for displaying visual content and, more particularly, to a mobile display that processes and displays visual content from one or more external sources.

### BACKGROUND

Billboards, signs, newspapers, posters, and flyers are conventional mediums for conveying information and ideas to the public. The information conveyed with these conventional mediums may generally comprise static information, such as advertisements and fixed promotional campaigns, and dynamic information, such as news, weather, stock quotes, and sports scores. Generally, public and private corporations, government agencies, and individuals will carefully craft the content and placement of their medium depending upon the characteristics of the audience that will view the content. For example, a corporation desiring to sell a high-end product to wealthy urbanities may erect a billboard in an affluent part of a major city. Conversely, an individual attempting to garner votes in a local election may canvass his relevant voting district with flyers and posters.

Unfortunately, conventional mediums of conveying information suffer from several shortcomings. First, conventional mediums are relatively expensive to widely deploy. The producers of the conventional mediums must manually disseminate them to their intended audience, which is a costly endeavor. Second, the producers of conventional mediums are incapable of updating the conveyed information after distribution. Thus, conventional mediums are not well suited to conveying dynamic information. Third, as previously discussed, the placement of a convention medium will determine its effectiveness. If adequate placement is not available, conventional mediums may not be pragmatic. Fourth, conventional mediums are difficult to tailor to specific regions or groupings of intended viewers. For example, the producer of a global advertising campaign will typically need to draft several versions of the advertisement in different languages, depending upon the countries in which the advertiser will disseminate the advertisement.

### BRIEF SUMMARY

A method and system for displaying visual content is disclosed. In some embodiments the system comprises a processor configured to process visual content that is to be displayed on the mobile display, a storage device coupled to the mobile display and adapted to store the visual content, and an interface configured to facilitate the transfer of the visual content from an external source to the storage device. In accordance with at least some embodiments of the invention, a system and associated method comprise sending a request to display data on a vehicular display device, configuring the vehicular display device based on the type of the request, and displaying the data on the vehicular display device

### BRIEF DESCRIPTION OF THE DRAWINGS

For a detailed description of exemplary embodiments of the invention, reference will now be made to the accompanying drawings in which:

FIG. 1 illustrates an exemplary system in accordance with embodiments of the invention;

FIG. 2 depicts the display device of FIG. 1 in greater detail;

FIG. 3 illustrates an exemplary mobile network in accordance with embodiments of the invention;

FIG. 4 illustrates a flow chart for an exemplary method of displaying static information in accordance with embodiments of the invention;

FIG. 5 depicts a flow chart for an exemplary method of displaying dynamic information in accordance with embodiments of the invention;

FIG. 6 illustrates an exemplary wireless infrastructure in accordance with embodiments of the invention;

FIG. 7 depicts a peer-to-peer network in accordance with embodiments of the invention;

FIG. 8 illustrates a plurality of display devices coupled together in accordance with embodiments of the invention; and

FIG. 9 depicts a flow chart for an exemplary method for displaying content on a plurality of interconnected display devices in accordance with embodiments of the invention.

### NOTATION AND NOMENCLATURE

In the following discussion and in the claims, the terms “including” and “comprising” are used in an open-ended fashion, and thus should be interpreted to mean “including, but not limited to”. Also, the term “couple” or “couples” is intended to mean either an indirect or direct electrical or communicative connection. Thus, if a first device couples to a second device, that connection may be through a direct connection, or through an indirect connection via other devices and connections.

### DETAILED DESCRIPTION

In this disclosure, numerous specific details are set forth to provide a sufficient understanding of the present invention. Those skilled in the art, however, will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise. Moreover, certain terms are used throughout the following description and claims to refer to particular system components. As one skilled in the art will appreciate, components may be referred to by different names. This document does not intend to distinguish between components that differ in name, but not function.

The following discussion is also directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

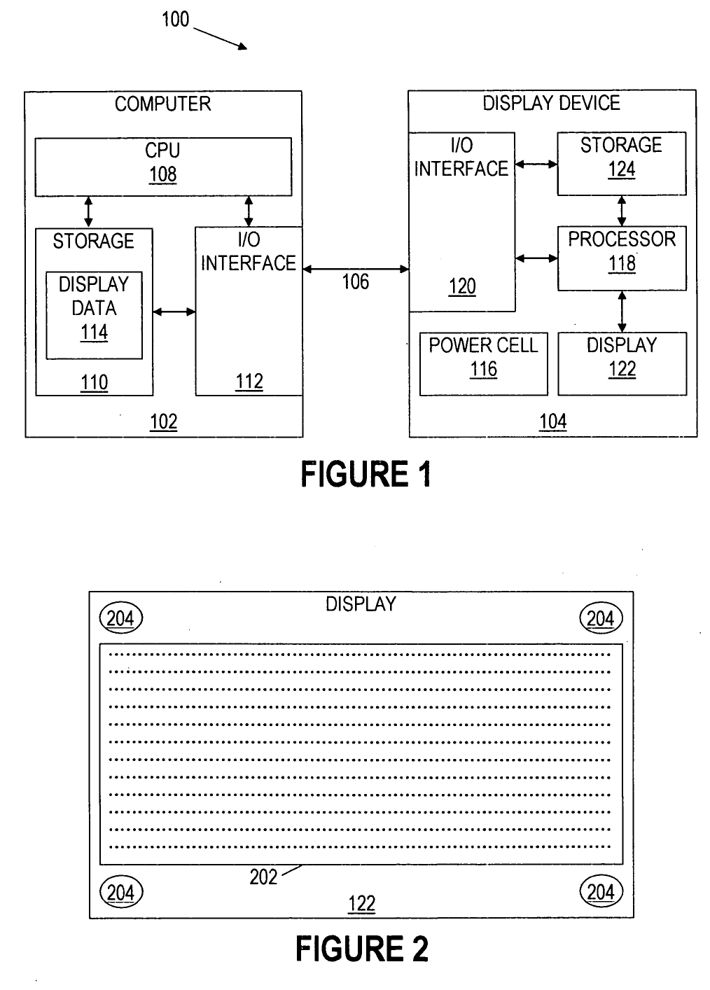

FIG. 1 illustrates a system 100 constructed in accordance with embodiments of the invention. System 100 comprises a computer 102 coupled to a display device 104 by a communications channel 106. The computer 102 may be any type of computer system, such as a laptop computer, a personal computer, or a stand-alone computer operated as a server. The computer 102 comprises a central processing unit (CPU) 108, a storage 110, and an Input/Output (I/O) interface 112. As illustrated in FIG. 1, the computer 102 may comprise a single CPU 108, or may comprise a plurality of CPUs arranged in a configuration where parallel computing may take place. The CPU 108 couples to the storage 110 which stores display data 114. The storage 110 may comprise any type of volatile and/or non-volatile memory, such as random access memory (RAM) and read only memory (ROM), or any other medium for storing information, such as a hard drive, universal serial bus (USB) flash drive, memory stick, cell phone, and iPod®. The display data 114 may comprise any type of static, semi-static, or dynamic visual content, such as still images and text, motion pictures, animated graphics, and advertisements in any type of representation, such an binary data. The storage 110 couples to the I/O interface 112 to transmit the display data 114 through the communications channel 106 to the display device 104.

As illustrated in FIG. 1, display device 104 comprises a power cell 116, a processor 118, an I/O interface 120, a display 122, and storage 124. The display data 114 may be transferred from the computer 102 to the display device 104 via the communications channel 106 and the I/O interfaces 112 and 120. The I/O interfaces 112 and 120 may comprise any communications interface adapted to send and receive data via the communication channel 106. Such communications interfaces may comprise a Wi-Fi, cellular, pager, or satellite transceiver, a USB interface for receiving a USB flash drive, a FireWire interface, or any other type of communications interface capable of receiving data through the communications channel 106, such as an interface adaptor for an iPod®.

The communications channel 106 comprises any type of wireless and/or wire line communications channel that facilitates the transfer of the display data 114 from the computer 102 to the display device 104. Depending upon the data rate desired, various wireless and wire line technologies may be employed. For example, in wireless embodiments, the communication channel 106 may employ a communications protocol or standard, such as Wi-Fi (i.e., Institute of Electrical and Electronics Engineers (IEEE) 802.11 and its variants), Global System for Mobile communication (GSM), Code-Division Multiple Access (CDMA) and its variants (e.g., Wideband CDMA (W-CDMA), Broadband CDMA (B-CDMA), Time Division CDMA (TD-CDMA), and CDMA2000), Orthogonal Frequency Division Multiplexing (OFDM) and it variants, General Packet Radio Service (GPRS), Enhanced Data rates for GSM Evolution (EDGE), any other second (2 G), third (3 G), or fourth (4 G) mobile technology, Bluetooth, and Infrared (IrDA). Paging technology, such as Post Office Code Standardization Advisory Group (POCSAG), FLEX, ReFLEX, and InFLEXion may also be used. In some wire line embodiments, a keyboard or other input device may be connected to the display device 104 to create and transfer the display data 114. In these wire line embodiments, the computer 102 is optional and the keyboard or other input device creates and facilitates the transfer of the display data 114 to the display device 104.

The processor 118 preferably includes a dock or oscillator that provides timing for the components of the display device 104. In at least some embodiments, the timing for the display device 104 is provided by a phase-locked-loop (PLL) circuit. The processor 118 may process, convert, modify, arrange, and/or transform the display data 114. In addition, the processor 118 may perform functions necessary for content to be displayed on the display 122 and for proper operation of the display device 104. The processor may comprise any type of software and/or hardware that is capable of processing the display data 114, such as Intel's PXA27x family of microprocessors, Texas Instruments' TCS3500 chip set, or a field programmable gate array (FPGA).

The storage 124 couples to the I/O interface 120 and stores data that is to be displayed on the display 122. The storage 124 may comprise any type of volatile memory and/or non-volatile memory, such as random access memory (RAM) and read only memory (ROM), or any other medium for storing information, such as a hard drive, Universal Serial Bus (USB) Flash drive, memory stick, cell phone, and an iPoD®. In some embodiments, the storage 124 contains preconfigured data and functions, such as compression/decompression algorithms, priority display functions, audio/video codecs, audio visualization functions, text translation functions, music lyric lookup functions, and dosed caption lookup functions. The processor 118 may utilize the preconfigured data and functions to perform tasks associated with the operation of the display device 104. For example, the processor 118 may utilize a text translation function stored in the storage 124 to translate display data text from one language to another before being displayed on the display 122. Another example includes the automated lookup of song lyrics. In this example, once an audio device, such as an iPod®, is connected to the display device 104 via the I/O interface 120, the processor 118 may execute the audio visualizations and lyric lookup functions for a particular song to display audio visualizations and the lyrics of the song on the display 122. Similarly, a dosed caption decoder may be stored in the storage 124 to provide the capability to display captions for visual content, such as movies, movie pictures, animations, and advertisements. Priority display functions may also be stored in the storage 124 to control the type of content displayed on the display 122. For example, a priority display function may determine when the display device 104 may display user-created content and when advertisements are displayed. As can be appreciated, such priority functions may control the type of content that is displayed on the display 122, thereby facilitating various types of advertising business models. For example, one business model may permit advertisements to be displayed on the display 122 a configurable percentage of the time that the display device 104 is active and operational. Under this exemplary business model, a user would only be able to display user-created content during times when advertisements were not being displayed, thereby creating a priority scheme for the various types of content. If the user attempts to display lower priority, user-created content while a priority function has locked out the user, the user's content may optionally be queued for display after the advertisements have been displayed. This queuing process may store the lower priority content in the storage 124.

In some embodiments, the preconfigured data and functions, as well as the priority display functions, may be stored external to the display device 104. In these embodiments, the display device 104 sends a request with data to the external source and receives a reply containing the data after it has been processed by the function indicated in the request.

In other embodiments, the communications channel 106 represents the physical transportation of data by a physical storage device, such as the transfer of data from the computer 102 to the display device 104 via a USB flash drive. In these embodiments a user physically connects a storage device containing the display data 114 to the display device 104. The display device 104 detects the connection of the storage device, accesses the data stored on the storage device, and displays this data on the display 122 after being optionally processed and formatted by the processor 118.

The display device 104 may optionally includes a global position locator to be used with in conjunction with a global position system (GPS). The global position locator allows the physical location of the display device 104 to be determined. The global position locator may be powered by the power cell 116 and may optionally utilize components of the I/O interface 120 to transmit its GPS signal.

In some embodiments, power cell 116 is coupled to a timer which detects the time that has elapsed since a predetermined condition has occurred. Such conditions may comprise the last time content was displayed on the display 122, the last time an active wireless connection was established by the I/O interface 120, or any other event detectable by the timer. After the timer is initialized and a predetermined time has elapsed from the occurrence of a condition, the display device 104 may enter into a power saving mode, in which non-critical circuitry is either powered off or set to a reduced power state, or turn off. As can be appreciated, such embodiments preserve the energy stored in the power cell 116, thereby increasing the amount of time that the power cell 116 may power the display device 104.

The power cell 116 may produce energy to fully or partially power the display device 104. The power cell 116 may comprise alkaline, nickel-cadmium (NiCd), or any other type of batteries. In at least some embodiments, renewable energy source, such as kinetic or solar power, are employed to power the display device 104. For example, solar power cells or panels may be employed to fully or partially power the display device 104. In at least some embodiments, the power cell 116 is used in conjunction with a secondary power source, such as a car battery, to power the display device 104.

FIG. 2 depicts the display 122 in more detail. The display 122 preferably comprises a grid 202 of light emitting diodes (LEDs) and one or more fasteners 204. LEDs are semiconductor devices that emit light when electrically biased in the forward direction. The color of the emitted light depends on the chemical composition of the semiconducting material used, and can be near-ultraviolet, visible or infrared. Although shown in FIG. 2 as a rectangular array of LEDs, grid 202 may comprise any pattern, such as square, circular, or a customized pattern of LEDs that provides enough resolution to be discernible by its interned viewer. In addition, the grid 202 may comprise display means other than LEDs, such as pixels of a plasma or liquid crystal display (LCD) screen, photosensors, organic light-emitting diodes (OLEDs), and solid state lighting (SSL) LEDs.

In at least some embodiments, the one or more fasteners 204 are adapted to fasten the display 122 and or the display device 104 to a vehicle. Although shown in FIG. 2 as occupying the corners of the display 122, the fasteners 204 may be placed in any desirable position and may comprise any suitable attachment means, such as suction cups and adhesive strips. In some embodiments, the display 122 is attached to the inside of a vehicle's translucent window. For example, the display 122 may be attached the inside rear window of a vehicle, such as a truck, van, car, bus, taxi, train, airplane, and military vehicle. The fasteners 204 preferably allow for the display 122 to be positioned in various angles, depending upon the desired viewing angle for the intended audience of the display 122. For example, in embodiments that employ suction cups to secure the display device 104 to the rear window of an automobile, arms may position the display device 104 away from the rear window to permit the display 122 to pivot. The capability to pivot the display 122 allows the display device 104 to be successfully mounted on rear windows of various angles and sizes, while preserving the desired viewing angle for viewers outside of the vehicle.

As can be appreciated, the foregoing discussion is directed to the design associated with a portable display system. Various additional components of the system 100, such as servers, databases, and software applications, may be utilized to implement each of the components of the computer 102 and the display device 104. Moreover, many of the components of the system 100 may be implemented in either hardware, software, or a combination thereof. In addition, in at least some embodiments, the display device 104 couples to a vehicle's control unit to display characteristics of the vehicle, such as current speed, direction, and fuel content. In related embodiments, the display device 104 assists nearby vehicle operators from determining the state of a vehicle that utilizes the display device 104. For example, when the operator of an automobile presses the brake pedal or activates a directional signal, the display device 104 may receive a signal from the automobile's circuitry indicating that the automobile is slowing down and/or making a turn. This information may be displayed on the display 122 as a message, for example “slowing down” or “right turn” to other vehicle operators. Because the display device 104 is capable of displaying static, semi-static, and dynamic content, such messages may employ special effects, such as animation, or may simply be presented as static text.

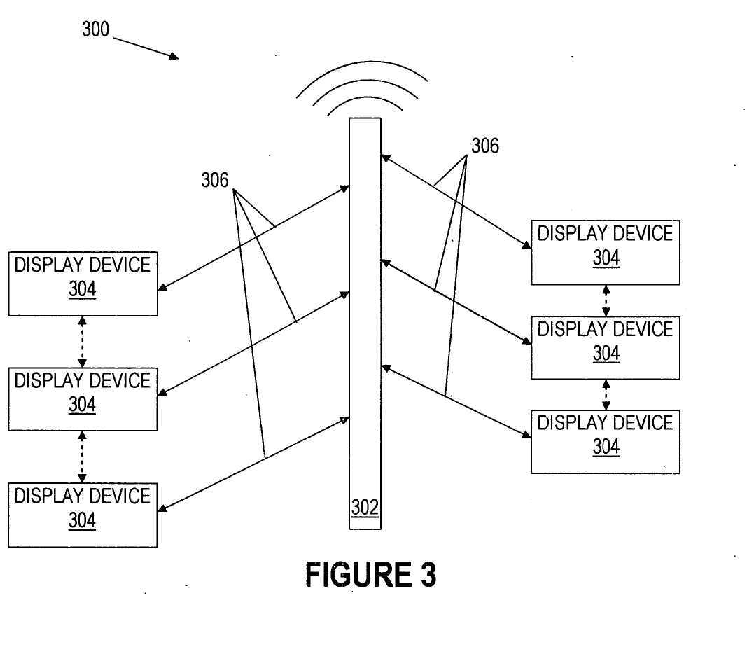

FIG. 3 illustrates an exemplary mobile network 300 in accordance with embodiments of the invention. The network 300 comprises one or more transmission towers 302 and a plurality of display devices 304 coupled together. The display devices 304 are coupled to the transmission tower 302 via transmission channels 306. The transmission tower 302 may be representative of a cellular tower, or any other transmission medium, such as a Wi-Fi access point or pager tower. As shown in FIG. 3, the display devices 304 may optionally be coupled together via communications channels to facilitate the transfer of data among the display devices 304, thereby creating a network of interlinked display devices. Each display device 304 may represent a client on the network 300. Accordingly, in some embodiments that employ Wi-Fi technology to connect the display device to the Internet via Transmission Control Protocol/Internet Protocol (TCP/IP), each display device 304 may be assigned a unique IP address. Although six display devices are illustrated in FIG. 3, any number of display devices may be connected to the network 300. Once a network of display devices is established, content may be selectively displayed on the networked display devices. For example, an advertiser may desire to display a particular advertisement in a particular region. After determining the desired region, the advertisement may be sent only to the networked display devices located in the particular region. The current location of the display device may be determined in a number of ways. For example, the location may be inferred from the display device's IP address or determined from a GPS locator embedded in the display device.

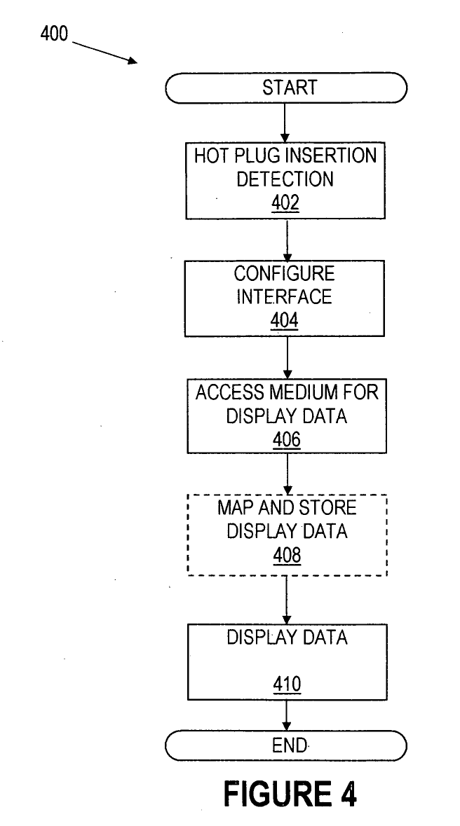

FIG. 4 illustrates a flow chart for an exemplary method 400 of displaying static information in accordance with embodiments of the invention. The method 400 starts when a user connects a storage device to a display device (402). Typically, the connection will be made when the display device is operating, referred to a hot-plug insertion. The display device automatically detects the connection and configures its I/O interface to handle the type of medium inserted (404). After this configuration, the data on the storage device is accessed for appropriate display data (406). In some embodiments of the invention, the display data is located in a pre-defined file in a predefined directory of the storage device. After a hot-plug insertion and initialization, the display device may automatically retrieve the display data from the storage device. The display data may then optionally be mapped to a data format recognized by the display device and/or stored in the storage of the display device (408). The mapping may uncompress and format the display data before storing the formatted display data to the storage of the display device. Lastly, the display data is displayed on the display of the display device (410).

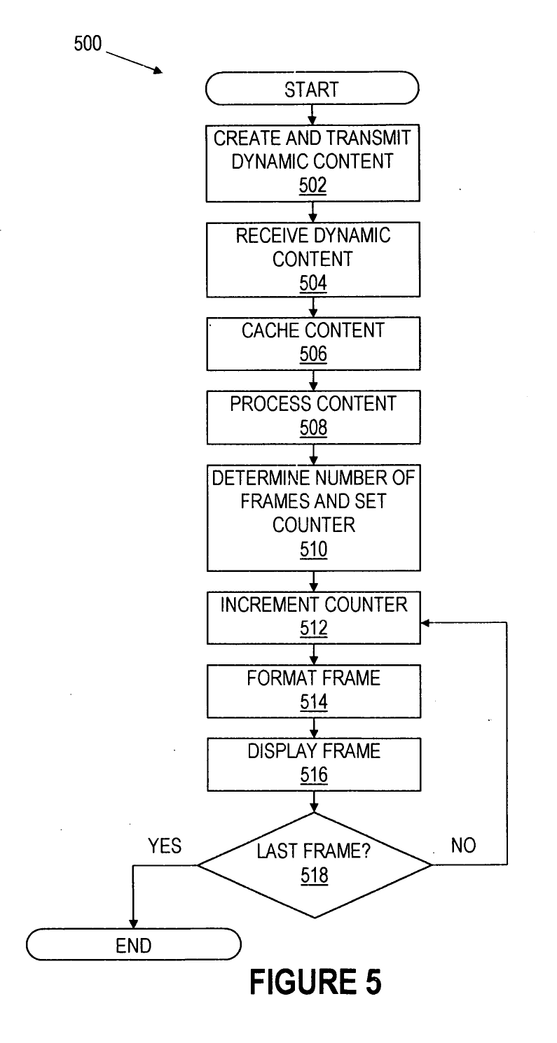

FIG. 5 illustrates a flow chart for an exemplary method 500 of displaying real-time, dynamic information in accordance with embodiments of the invention. The method 500 starts when dynamic content is created and transmitted to a display device (502) via a transmission tower. The display device receives the content (504), and the content is cached in the storage of the display device (506). The content may then be processed to ensure that the information content is in the form desired to be displayed by the display device (508). It is during this step that any predefined functions, such as text translation, resolution and dimension modifications, and decompression are performed. The dynamic content is then analyzed to determine the number of frames that are to be display and the corresponding frame rate associated with the dynamic content (510). It is at this step that a counter is initialized and set to track the frames to be displayed. The counter is then incremented (512), and the current frame of the dynamic content is formatted so that is can be displayed on the display of the display device (514). The current frame is then displayed on the display of the display device (516). If the current frame is the last frame of the dynamic content (518), the process ends. If the current frame is not the last frame, the frame counter is incremented (512), the next frame is formatted (514) and displayed on the display (516). This process continues until the last frame of the dynamic content is displayed (518).

Although the steps for methods 400 and 500 are given in a predefined order, the steps may be similarly performed out of order if desired. In addition, some steps may be added or dismissed from the foregoing exemplary methods when desirable. For example, when the display device is connected to a network, the device may send a confirmation message after completing the display of static of dynamic content. This message may serve numerous purposes, for example, as a confirmation for an advertiser that an advertisement was properly displayed. In addition, the methods may be performed on a real-time basis. For example, when a user sends dynamic content to a transmission tower, this content is sent to the display device and displayed almost instantaneously, or within a short and predictable time frame. Because the storage of a display device may contain preconfigured data and functions that decompress and process the display data, the total bandwidth needed to delivery content in a real-time manner is reduced. For example, pager technology operating with a FLEX or ReFLEX protocol may be employed for real-time content delivery at 6,400 bps or lower.

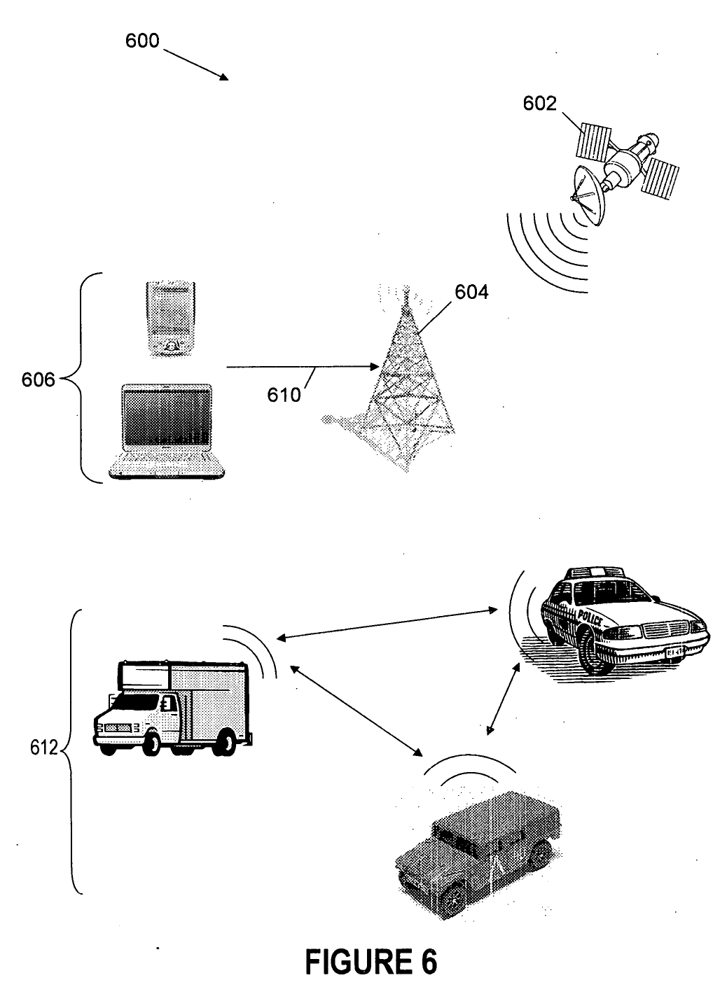

FIG. 6 illustrates an exemplary wireless infrastructure 600 in accordance with embodiments of the invention. The infrastructure 600 comprises a satellite 602, a wireless base station 604, one or more wireless input devices 606, and a vehicular network 612. The wireless input devices 606 couple to the base station 604 via wireless communications channel 610. The vehicular network 612 comprises a plurality of vehicles coupled together via the I/O interface of a display device that is attached to each vehicle. A user of the one or more wireless input devices 606 may send requests to the base station 604 to transmit data to the vehicular network 608 via the communications channel 610. Upon receiving such requests, the base station 604 may send data to the vehicular network 612, thus establishing communications between the wireless input devices 606 and the vehicular network 612. Alternatively, a user may send a request to the base station 604, which then is transmitted to the satellite 602. The satellite 602 may then transmit a signal to the vehicular network 612, thereby establishing communications between the wireless input devices 606 and the vehicular network 612. In embodiments that employ a GPS locator, the satellite 602 becomes part of a positioning system to determine the location of a vehicle connected to the vehicular network 612.

A vehicular network in accordance with some embodiments of the invention comprises a peer-to-peer (P2P) network of display devices. This P2P vehicular network is built on the connections of individual displays devices rather than one central network. The P2P network relies on individual users to function as both clients and servers. Specifically, data is shared between display devices that access data from other display devices and allow other display devices to access their own data. In at least some embodiments, each display device acts as a relay to extend the coverage of the P2P network. For example, a wireless device that is within the range of the network created by transmission towers may relay information to wireless devices outside of this range but within the range of a particular device.

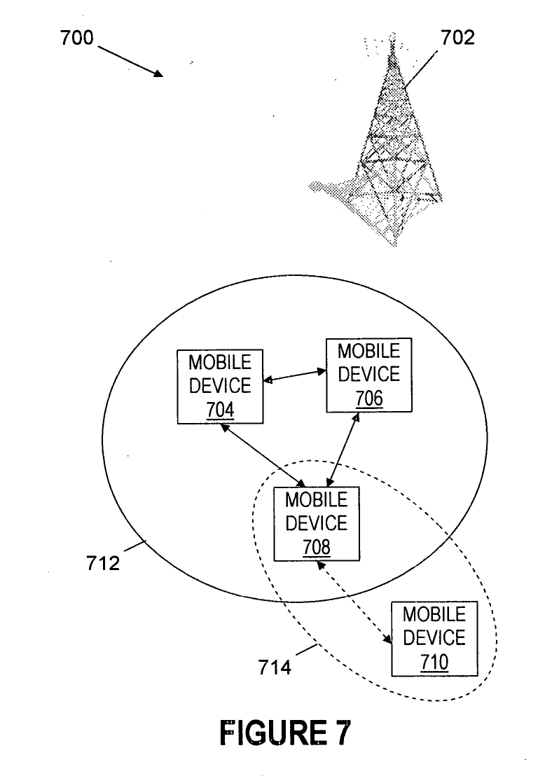

FIG. 7 illustrates a peer-to-peer network 700 in accordance with embodiments of the invention. The network 700 comprises one or more transmission towers 702 and a plurality of mobile devices 704-710. The transmission tower 702 has an effective range within the region 712. Each mobile device 704-710 also comprises a transceiver with an effective range. For example, mobile device 708 has a range within the region 714. The mobile device 708 may act as a relay to provide connectivity for the mobile device 710. As can be appreciated, a P2P network as illustrated in FIG. 7 has wide applications. For example, a mobile device within a building may not have access to a desired wireless infrastructure. Some mobile devices, however, within or near the building may have access to the desired infrastructure. For example, mobile users that are near windows may have connectivity to a particular wireless network that mobile users far within the building may not. The mobile device with access may act as a relay for the mobile devices without access. Thus, the effective range of the network is increased. Logic internal to the mobile device may automatically negotiate the connections necessary to establish such a network.

In some embodiments, the P2P network 700 facilitates the determination of vehicle congestion by determining the location of display devices. For example, display devices may transmit a signal that contains the location of other active display devices. Logic within each display device may aggregate the location information to determine regions with excessive build-up of display devices. This information may be displayed on the display device, or sent through the network and externally processed by a traffic congestion management system.

In at least some embodiments the P2P network is a distributed, self-organizing network. In such embodiments, neither data requests nor transmissions pass through any central server. The P2P network is multi-layered, so that more powerful mobile devices get to be hubs, commonly referred to as supernodes. Any mobile device that acts as a client may become a supernode if it meets the criteria, such as processing power, bandwidth, and latency. Network management is fully automatic because supernodes appear and disappear according to demand. Moreover, supernode functionality is built into the mobile device via hardware, software, or a combination thereof. In order to initially connect to the P2P network, a list of supernode device identifiers is stored in the storage of the mobile device. A mobile client attempts to contact the device identified as supernodes, and as soon as it finds an active supernode, it requests a list of currently active supernodes, to be used for future connection attempts. The supernode communicates with other supernodes in order to satisfy data requests and connections. A mobile client may then connect directly to a peer to exchange information. The UUHash algorithm may optionally be employed in the P2P network to share information among the mobile devices.

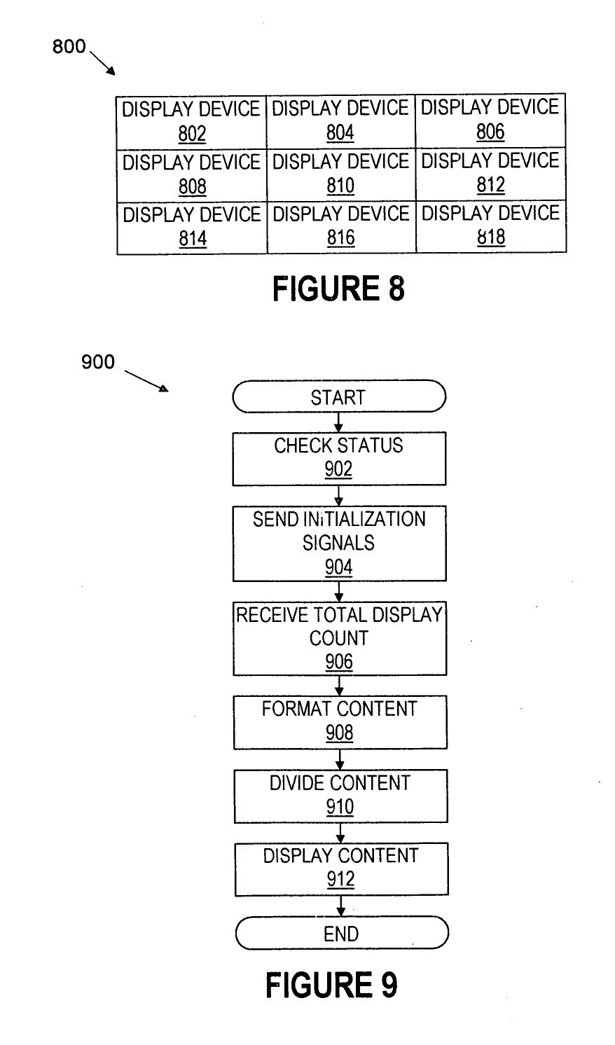

In accordance with at least some embodiments of the invention, a display device is capable of coupling to other display device to increase the total viewable area. In these embodiments, a plurality of display device are coupled together and operated as a single display. One of the display devices acts as the master display device, sending signals to the one or more slave devices. Such a configuration allows for the total viewable area of the display to be increased. FIG. 8 illustrates such a multi-panel display 800. As shown in FIG. 8, six display devices 802-818 are coupled together to form the multi-panel display 800 in a three by three configuration. Display device 802 may serve as the master device by sending and receiving signals to and from the slave devices 804-818 to display the appropriate content on the multi-panel display 800.

FIG. 9 illustrates an exemplary procedure 900 employed by the master display device in a multi-panel display configuration. The procedure 900 begins when a plurality of display devices that are coupled together check their status to see if they are the master device (902). The status of each device may be stored in the storage of each device. For example, a logic value of one may indicated that the device is the master device and a logic value of zero may indicated that the device operates as a slave. Such values may be stored in a status bit accessible by the display devices. The master device may then send initialization signals to all coupled slave devices (904). Such initialization may include synchronization sequences to align the timing of each slave device with that of the master device. The master device then determines the total number of connected slave devices by receiving a signal from each slave (906). The master may use the total number of coupled displays to format the content that is to be displayed (908). After formatting, the master device divides the content in accordance with the number of coupled displays (910). After the content has been divided, the content is displayed on the plurality of coupled displayed after the master device sends the appropriate content to the appropriate display device (912). The procedure 900 creates a large viewable area from multiple smaller display devices.

The above discussion is meant to be illustrative of the principles and various embodiments of the present invention. Numerous variations and modifications will become apparent to those skilled in the art once the above disclosure is fully appreciated. For example, a display device may be coupled to the control circuitry of a vehicle. A wireless infrastructure may then facilitate the control of the vehicle and display of messages. As can be appreciated, such variations allow for unmanned operation of a vehicle and display of messages. It is intended that the following claims be interpreted to embrace all such variations and modifications.

What is claimed is:

1. A mobile display, comprising:
a processor configured to process visual content that is to be displayed on the mobile display;
a storage device coupled to the mobile display and adapted to store the visual content; and
an interface configured to facilitate the transfer of the visual content from an external source to the storage device.

2. The mobile display of claim 1 wherein the processor modifies the visual content based on the physical location of the mobile display.

3. The mobile display of claim 1 wherein the interface is configured to facilitate hot-plug insertions.

4. The mobile display of claim 1 wherein the interface comprises a wireless communications device that employs a wireless communication technology selected from the group consisting of Wi-Fi, cellular, satellite, and pager.

5. The mobile display of claim 4 wherein the wireless communication device connects to a distributed, self-organizing network of other mobile displays, wherein the network comprises a pluralities of nodes and at least one supernode that acts as a informational hub for the network.

6. The mobile display of claim 1 further comprising a timer that triggers a reduction in power consumption for the mobile display.

7. The mobile display of claim 1 wherein the visual content comprises real-time, dynamic advertising that has been decompressed by the processor.

8. The mobile display of claim 1 further comprising a power cell that powers the mobile display, at least in part, using solar energy.

9. The mobile display of claim 1 wherein the interface couples to internal control circuitry of a vehicle to display characteristics of the vehicle to observers external to the vehicle.

10. A method, comprising:
sending a request to display data on a vehicular display device;
configuring the vehicular display device based on the type of the request; and
displaying the data on the vehicular display device.

11. The method of claim 10 further comprising sending a confirmation signal from the vehicular display device in response to the data being successfully displayed.

12. The method of claim 10 further comprising decompressing the data before displaying the data.

13. The method of claim 10 further comprising prioritizing the display data into at least two groups and displaying the group with the higher priority.

14. The method of claim 10 wherein the vehicular display device is networked with other vehicular display devices.

15. The method of claim 10 wherein configuring the vehicular display device comprises initializing a counter and a timer.

16. The method of claim 10 furthering comprising obtaining the physical location of the vehicular display device.

17. A portable device, comprising:
means for processing visual information;
means for storing the visual information coupled to the means for processing visual information; and
means for transferring the visual information from an external source to the means for storing the visual information.

18. The portable device of claim 17 further comprising a means for wirelessly connecting to a network.

19. The portable device of claim 17 further comprising a means for translating the visual information from a first language to a second language.

20. The portable device of claim 17 further comprising a means for determining the location of the portable device in relation to other portable devices.
